(19) United States
(12) Patent Application Publication
(10) Pub. No.: US 2026/0100013 A1
(43) Pub. Date: Apr. 9, 2026

(54) MULTISPECTRAL IMAGING SYSTEMS AND METHODS

(71) Applicant: The University of Melbourne, Melbourne, Victoria (AU)

(72) Inventors: Ranjith RAJASEKHARAN UNNITHAN, Melbourne, Victoria (AU); Noor E. Karishma SHAIK, Melbourne, Victoria (AU); Bryce Jackson WIDDICOMBE, Melbourne, Victoria (AU); Luke Benjamin WESTON, Melbourne, Victoria (AU); Nandakishor -, Melbourne, Victoria (AU); Ampalavanapillai NIRMALATHAS, Melbourne, Victoria (AU); Marimuthu Swami PALANISWAMI, Melbourne, Victoria (AU)

(21) Appl. No.: 19/113,879

(22) PCT Filed: Sep. 21, 2023
(86) PCT No.: PCT/AU2023/050911

§ 371 Date: Mar. 20, 2025

(30) Foreign Application Priority Data
Sep. 21, 2022 (AU) 2022902738

(51) Int. Cl. G06V 10/143; G06V 10/147; G06V 10/58; G06V 10/764; G06V 10/774; H04N 23/16

(52) U.S. Cl. CPC G06V 10/143; G06V 10/147; G06V 10/58; G06V 10/764; G06V 10/774; H04N 23/16

(57) ABSTRACT

A sample analysis method, comprising: obtaining a multispectral image (e.g., a thermal multispectral image) of a first sample of a sample class, said multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and applying a sample image analyser to said multispectral image, wherein the sample image analyser implements a pretrained machine learning algorithm configured to generate a reconstructed spectrum comprising a second number (m) of spectral points, wherein the second number is larger than the first number (m>n), wherein the first number is two or greater (n≥2), and wherein the unique spectral bands are arranged to cover an operating band of the long-infrared spectrum, and related device and system.

### FIELD OF THE INVENTION

The invention generally relates to multispectral imaging, for example thermal multispectral imaging, and processing methods thereof.

### BACKGROUND

Light and compact thermal imaging spectrometers with multiwavelength sensitivities have promising applications in minerals classification, precision agriculture, non-invasive disease diagnosis, wildfire detection, and environmental monitoring. Existing compact thermal spectrometers lack spatial image information limiting their real-world applications. Furthermore, their operation traditionally requires an active blackbody source which is not readily available in resource-constraint settings.

Reference herein to background art is not an admission that the art forms a part of the common general knowledge of the person skilled in the art, in Australia or any other country.

### SUMMARY

According to an aspect of the present disclosure, there is provided a sample analysis method, comprising: obtaining a multispectral image of a first sample of a sample class, said multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and applying a sample image analyser to said multispectral image, wherein the sample image analyser implements a pretrained machine learning algorithm configured to generate a reconstructed spectrum comprising a second number (m) of spectral points, wherein the second number is larger than the first number (m>n), wherein the first number is two or greater (n≥2), and wherein the unique spectral bands are arranged to cover an operating band of the long-infrared spectrum.

The multispectral image may be a thermal multispectral image. The operating band may correspond to, or substantially to, the range of wavelengths 7-14 μm or 2-5.5 μm. In an alternative, the operating band corresponds to, or substantially to, an infrared band such as the range of wavelengths 0.78-1 μm (e.g., near infrared) and/or to the visible band such as the range of wavelengths 0.4-0.78 μm. Each spectral band may be characterised by a unique peak transmission wavelength. In a particular embodiment, the first number is six (n=6) and the second number is 64 (m=64).

Typically, the multispectral image comprises an array of multispectral pixels, each having a number of components equal to the first number (n) derived from the component images. A reconstructed spectrum may be generated for two or more, or all, multispectral pixels of the multispectral image. A spectral filter may be applied to each multispectral pixel of the multispectral image preconfigured to estimate the actual intensity for each spectral band based on predetermined weighted combinations of a plurality of the spectral bands. The predetermined weightings may be determined by reference to multispectral images obtained of a heatbed having a controllable blackbody radiation profile.

Optionally, the pretrained machine learning algorithm is trained according to the steps of: generating a training set comprising a plurality of training images, each training image being a multispectral image captured of a particular known sample type of the sample class; obtaining at least one known spectrum for the sample type, said known spectra having at least a resolution equal to the second number (m); and training the machine learning algorithm using the training set and using the at least one known spectrum as a ground truth. The machine learning algorithm may implement an encoder-decoder architecture, optionally comprising one or more of: an encoder-decoder architecture where a series of convolutional and pooling layers are in the encoder path and/or up-sampling and transposed deconvolutional layers are implemented in the decoder path; and a Leaky RELU activation function for introducing non-linearity. The training set may include training images of a same sample type obtained at different temperatures of the sample type.

Optionally, the multispectral image is obtained from an imager comprising: a plurality of image sensors, each associated with a unique one of the spectral bands and configured to generate the component image corresponding to its spectral band, arranged such that each image sensor is enabled to simultaneously capture an image of an imaging region. Optionally, the multispectral image is obtained from an imager comprising: at least one integrated image sensor associated with a unique two or more of the spectral bands and configured to generate the component images corresponding to each of its spectral bands. Each image sensor may comprise: a sensor configured for capturing a two-dimensional image, and a bandpass filter configured to limit the sensitivity of the sensor to the corresponding spectral band of the particular image sensor. At least one bandpass filter may comprise a plasmonic element for bandpass filtering. The image sensors may be optically coupled to an optical system, and the optical system may be configured for enabling simultaneous imaging of the imaging region by the imager sensors. The imager optionally further comprises one or more of: a reference thermal sensor; a range sensor; and a visible light sensor. The, or each, image sensor may be actively cooled.

In an implementation, the sample class is minerals and the sample being analysed is known to be of said sample class.

According to another aspect of the present disclosure, there is provided a sample analysis system comprising: an imager configured to capture multispectral images of a first sample of a sample class, each multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and an image processor configured to apply a sample image analyser to said multispectral image, wherein the sample image analyser implements a pretrained machine learning algorithm configured to generate a reconstructed spectrum comprising a second number (m) of spectral points, wherein the second number is larger than the first number (m>n), wherein the first number is two or greater (n≥2), and wherein the unique spectral bands are arranged to cover an operating band of the long-infrared spectrum.

According to yet another aspect of the present disclosure, there is provided a camera imaging device comprising: an imager configured to capture thermal multispectral images of a first sample of a sample class, each multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and an image processor configured to apply a sample image analyser to said multispectral image, wherein the sample image analyser implements a pretrained machine learning algorithm configured to generate a reconstructed spectrum comprising a second number (m) of spectral points, wherein the second number is larger than the first number (m>n), wherein the first number is two or greater (n≥2), and wherein the unique spectral bands are arranged to cover an operating band of the long-infrared spectrum, wherein the imager comprises either or both of: a plurality of image sensors, each associated with a unique one of the spectral bands and configured to generate the component image corresponding to its spectral band, arranged such that each image sensor is enabled to simultaneously capture an image of an imaging region; and at least one integrated image sensor associated with a unique two or more of the spectral bands and configured to generate the component images corresponding to each of its spectral bands.

A computer program, for example embodied within a computer readable storage medium, is provide according to an aspect, said computer program comprising code configured to cause a computer to implement the methods herein described, for example, with particular reference to the image analyser.

As used herein, the words “comprise”, “include”, and “having”, or variations such as “comprises”, “comprising”, “includes”, and “including”, are used in an inclusive sense, i.e., to specify the presence of the stated features but not to preclude the presence or addition of further features in various embodiments of the invention.

### BRIEF DESCRIPTION OF THE DRAWINGS

One or more embodiments of the invention will hereinafter be described with reference to the accompanying figures, in which:

FIG. 1 shows an imaging system for thermal multispectral imaging of a sample, according to an embodiment;

FIGS. 2A and 2B illustrate the operation of a thermal multispectral sensor;

FIG. 3 shows a thermal imager, according to an embodiment, having an arrangement of six image sensors;

FIG. 4 shows a relative positioning of a thermal sensor and a bandpass filter of an image sensor;

FIG. 5 shows a plasmonic element of a bandpass filter, according to an embodiment;

FIG. 6 shows a schematic representation of the imaging region being the commonly viewed area of a plurality of image sensors;

FIG. 7 shows an illustration of various embodiments with additional sensors including a reference thermal sensor, a range sensor, and a visible light sensor;

FIG. 8 shows a method for capturing a thermal multispectral image and/or component images thereof;

FIG. 9 shows a representation of the interaction between the thermal imager and image processor having a spectral reconstruction module;

FIG. 10 shows example training results for the image analyser; and

FIGS. 11A and 11B show results from adapting the image processor for use in the near-infrared and visible spectra.

### DESCRIPTION OF EMBODIMENTS

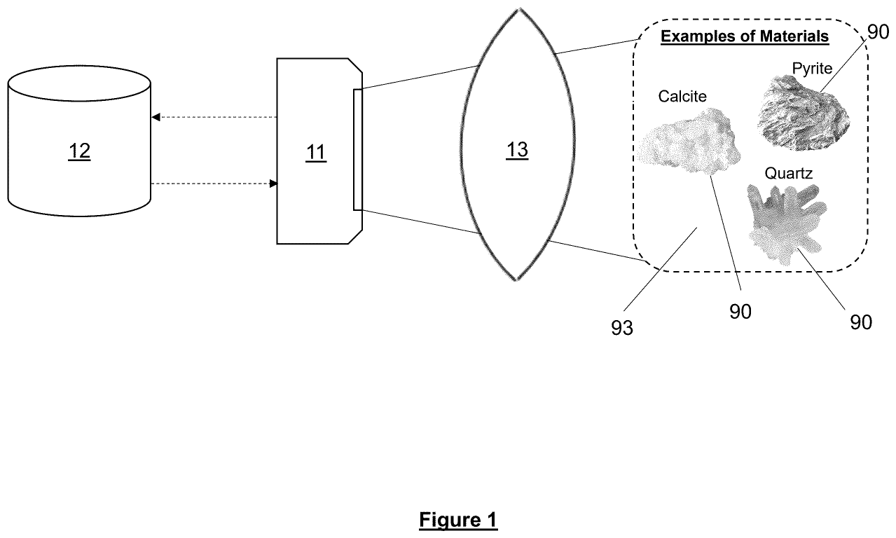

FIG. 1 shows an imaging system 10 for thermal multispectral imaging of a sample 90, according to an embodiment. The imaging system 10 comprises a thermal imager 11 and an image processor 12.

The image processor 12 is generally implemented by computer program executed by a suitably configured processor. The term “processor” should be understood as any suitable hardware for implementing the functionality of the image processor 12. To this end, the processor can comprise a single-or multi-core central processing unit (CPU), which can be functionally interfaced with a graphics processing unit (GPU). The processor can correspond to a general processing unit or a specifically configured processing unit. For example, certain functions of the image processor 12 may be implemented by a field-programmable gate array (FPGA). The image processor 12 can be implemented, in whole or in part, within a networked computing environment, for example, a cloud computing environment. The processor is interfaced with a memory, which can be understood as providing a storage space for program code as well as data used and/or generated by the image processor 12 as well as a working space for dynamic and transitory data generated through operation of the image processor 12. Typically, the memory comprises both a non-volatile memory (e.g., for permanent storage of program code and data) and a volatile memory (e.g., for providing the working space); the computer program can therefore be embodied within a computer readable storage medium (preferably, a non-transitory medium). The memory itself can be spread over multiple hardware devices, for example, as is the case in a cloud computing environment. For example, the memory can comprise one or more of: flash memory, read only memory (ROM), programmable memory (for example, PROM, EPROM and/or EEPROM memory), dynamic random-access memory (DRAM), static random-access memory (SRAM), magnetic storage such as hard disk drive(s), and optical storage media such as CD and DVD discs. Similarly, the thermal imager 11 is typically controlled by a processor interfaced with a memory.

The processor of the image processor 12 and/or thermal imager 11 can be interfaced with a network interface enabling data communication over a network, such as the Internet and/or a local intranet. The network interface can comprise either or both of a wired network interface and a wireless network interface. Wired network protocols can be implemented as electrical communication (e.g., Ethernet) and/or optical communication (e.g., fibre optic communication). Typically, the network data is transmitted as packets, for example, according to the IPv4 or IPv6 protocols. The image processor 11 and/or thermal imager can comprise an input/output interface for local data communications, which may not comprise a network as such. For example, such communications can be via a wired serial or parallel data bus such as USB and/or local wired protocol such as Bluetooth.

As shown, the thermal imager 11 is in data communication with the image processor 12 to thereby enable data captured by the thermal imager 11 to be transferred to the image processor 12. However, other arrangements can be utilised depending on the system requirements. For example, data captured by the thermal imager 11 can be stored in a removable data storage of the thermal imager 11 and transferred via transfer of the removable data storage from the thermal imager 11 to the image processor 12. In another example, the image processor 12 is integrated with the thermal imager 11 such that each has access to a common memory space thereby enabling direct access of the image processor 12 to image data captured by the thermal imager 11 (for example, the thermal imager 11 is controlled via processing hardware also implementing the image processor 12). Typically, the system 10 comprises an optical system 13 configured to enable image capture of an imaging region 93 (which typically includes the sample 90)—for example, the optical system 13 comprises one or more lenses. In an embodiment, the thermal imager 11 and image processor 12 are embodied in as a unitary, portable, thermal camera imaging device (that is, both image capture and image processing are implemented by hardware wholly contained within a portable housing).

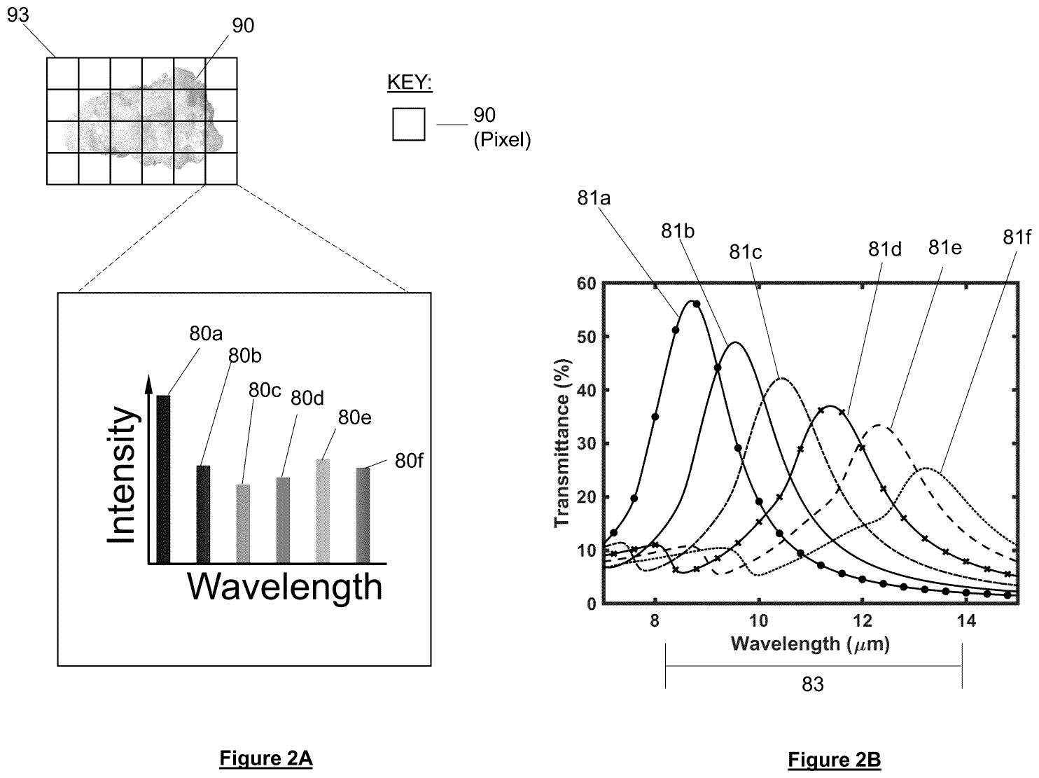

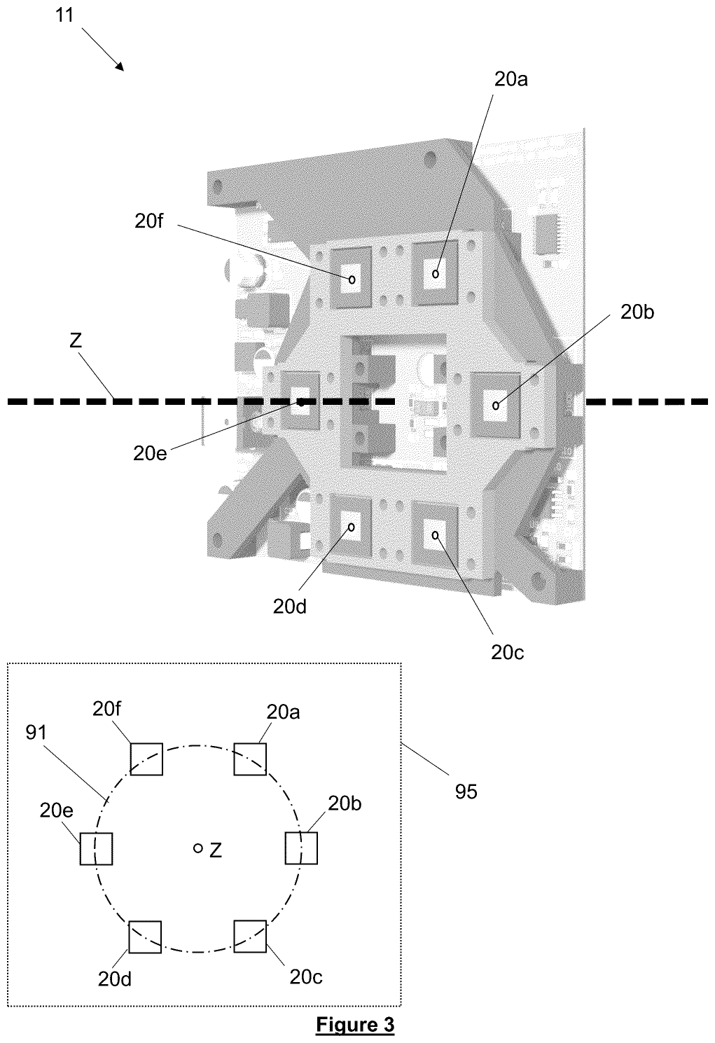

The thermal imager 11 is configured for generating a “thermal multispectral image” of the imaging region 93. Referring to FIG. 2A, each pixel 94 of the multispectral image has associated with it intensity information for each of a plurality of thermal bands 80. As used herein, the term “thermal band” refers to a sensitivity to wavelengths (or, equivalently, frequencies) of electromagnetic radiation associated with infrared radiation emitted by an object due to its temperature (e.g., blackbody radiation). In the embodiments described herein, each thermal band 80 is sensitive within an operating band 83 corresponding to a range of wavelengths within the long-infrared portion of the spectrum (for example, about 8-14 μm). Each thermal band 80 can be characterised by its peak sensitivity. FIG. 2B shows simulated results indicating peaks 81a-f.

Relevantly, there is overlap in the sensitivity of adjacent thermal bands 80. For example, thermal band 80a and thermal band 80b have an overlapping portion 82. Other adjacent thermal bands 80 have similar overlaps.

In an embodiment, as shown in FIG. 3, the thermal imager 11 comprises two or more discrete image sensors 20 (in the particular example shown, there are six sensor elements 20a-20f). The smallest number of discrete image sensors 20 is dependent on the spectral accuracy required for the particular implementation. Each image sensor 20 is associated with a unique thermal wavelength band—in this case, each sensor element 20 corresponds to the thermal band 80 having a corresponding suffix (i.e., sensor element 20a corresponds to thermal band 80a). It should be understood that the association between thermal band 90 and a particular sensor element 20 is made for convenience but should not be seen as limiting; for example, the particular relative positions of the sensor elements 20 may differ from that implied by FIG. 3. Typically, a processor of the thermal imager 11 is arranged to control the operation of the image sensors 20 as well as, depending on the embodiment, any other controllable hardware elements of the thermal imager 11.

As shown, the image sensors 20 are spaced apart from one another. For example, as shown in inset 95 (schematically illustrating a top-down view of the arrangement of image sensors 20 with respect to optical axis Z), the image sensors 20 can be positioned at substantially equal distances from a central optical axis (Z) defined with respect to the optical system 13, which may thereby advantageously provide a substantially symmetric illumination of the imaging region 93. As shown, the image sensors 20 are substantially spaced at equal distances around an imaginary circle 91 centred on the optical axis (Z).

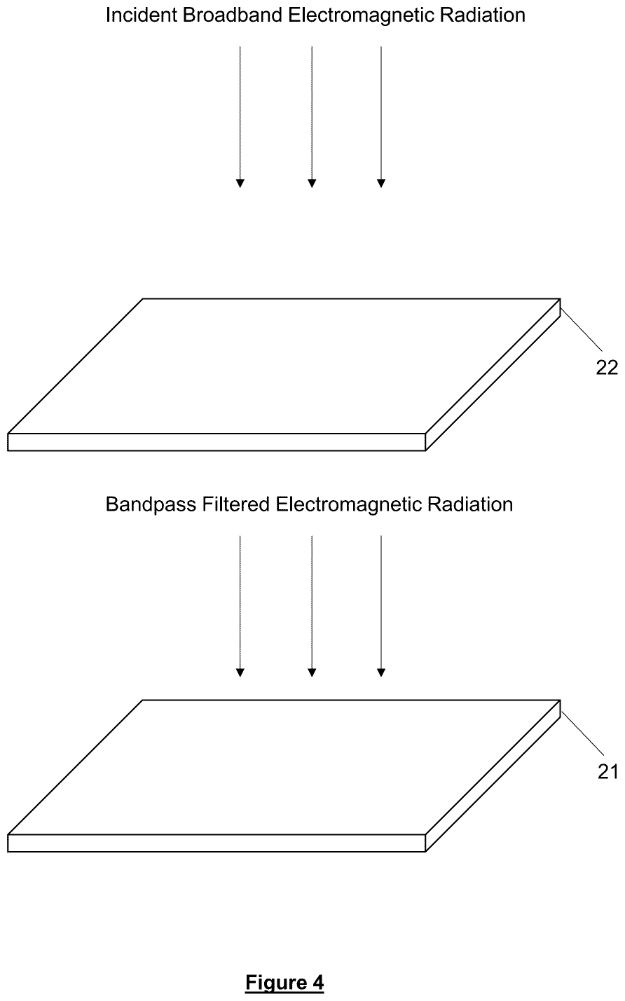

FIG. 4 shows a representation of an image sensor 20, according to an embodiment. The image sensor 20 comprises a thermal sensor 21 and a bandpass filter 22 positioned in the optical path before the thermal sensor 21 (as shown by arrows indicating incident broadband electromagnetic radiation (here, “broadband” simply means typically including a broader range of wavelengths than passed by the bandpass filter 22)); therefore, electromagnetic radiation incident on the thermal sensor 21 (more particularly, a sensitive region of said thermal sensor 21) from the sample 90 is bandpass filtered according to the properties of the bandpass filter 22. Advantageously, this approach allows for the use of identical thermal sensors 21 for two or more image sensors 22 (for example, it may be preferable that all image sensors 20 comprise an identical thermal sensor 21). In an implementation, the thermal sensors 21 are FLIR Lepton® sensors by Teledyne FLIR LLC, which provide lightweight and uncooled monochrome sensing in the desired operating range of 8-14 μm. Other ranges can be utilised, for example, one or more thermal sensors 21 can operate in the range 2-5.5 μm. It should be noted that the figure shows the thermal sensor 21 and bandpass filter 22 as having a significant separation, which is merely for illustrative purposes.

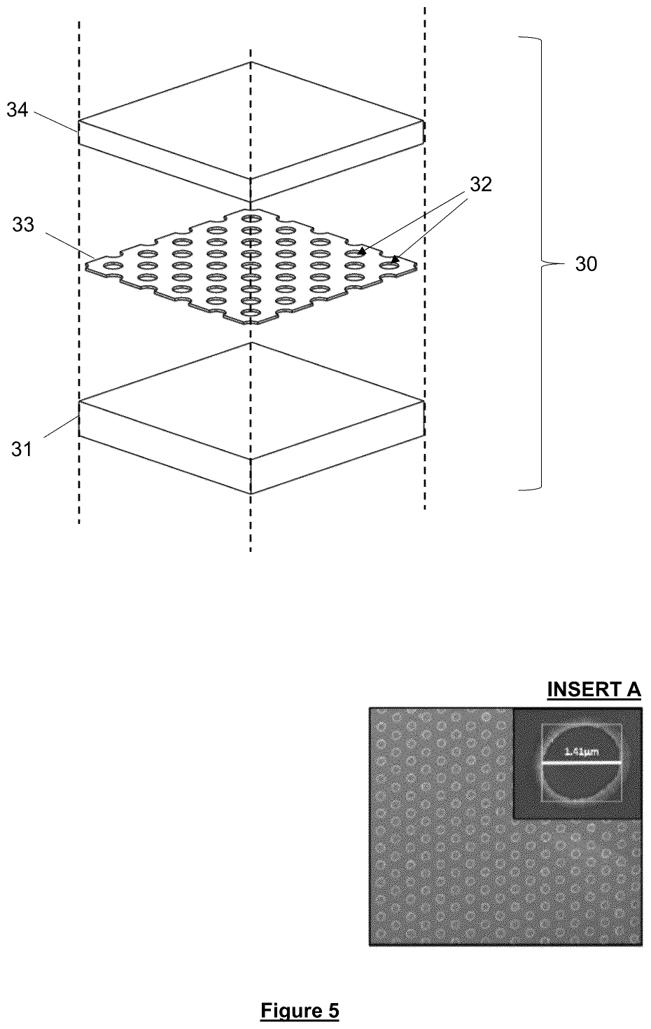

Referring to FIG. 5, according to an embodiment, one or more (for example, all) bandpass filters 22 utilise plasmonic-based structures (herein, “plasmonic element 30”). For example, Reference [1] (incorporated herein by reference) describes plasmonic-based thermal bandpass filters suitable for use as the bandpass filters 22 described herein, as is therefore incorporated herein in its entirety.

As shown, the plasmonic element 30 comprises a substrate 31 having on one surface a conducting layer 33 in which an array of plasmonic structures 32 is formed. Plasmonic structures 32 are subwavelength conducting (typically, the conductor is a metal) nanostructures that cause extreme localisation of electromagnetic fields to create surface plasmon resonance modes in response to illumination with light of a suitable wavelength. The particular wavelengths to which the plasmonic structures 32 are responsive is determined, among other parameters, by the size, shape, and pitch (i.e., distances between adjacent plasmonic structures 32). The plasmonic structures 32 can be defined by the presence or absence of the conductor; in the case of FIG. 5, each plasmonic structure 32 can be understood as a “hole” in conducting layer 33 (the resonances are created between these absences in the copper conducting layer 33). Other plasmonic structures 32 are known, including those which extend from or into the surface 31 in which a conducting layer is both found within the plasmonic structures 32 and the region of the surface 31 outside said structures 32; here, the resonances are created through the conducting disconnect between the plasmonic structures 32 and the remaining surface 31. For example, plasmonic structures 32 can take the form of gratings, nanorods, coaxial geometries, and multilayer metal-dielectric structures.

The plasmonic element 30 of FIG. 5 utilises an array of micron-sized holes (plasmonic structures 32) in a “noble metal” conducting layer 33 (in this case, a 75 nm Copper film) located on an infrared dielectric substrate 31 (i.e., a dielectric substrate with suitably high transmissivity for the long-infrared wavelengths utilised by the thermal sensors 20). The conducting layer 33 is encapsulated with a protective layer 34 (in this case comprising Germanium) in order to prevent the oxidation of the conducting layer 33 and to ensure the plasmonic resonances at top and bottom surfaces of conducting layer 33 are at substantially the same wavelength, which may advantageously ensure a suitably narrow bandpass filter (e.g. as per the Full Width Half Maximum (FWHM)). Also shown (Insert A) is a scanning electron microscope image of a fabricated plasmonic element 30 with a pattern of holes with pitch of 3.3 μm and hole diameter 1.75 μm, with the holes arranged hexagonally. It should be noted that FIG. 5 shows an exploded view of elements 31, 33, and 34.

In an embodiment, the design of a particular plasmonic element 30 can be based on computational simulations, for example using finite element methods (e.g., as provided with the COMSOL Multiphysics® platform) in order to produce optimum transmission peak wavelengths corresponding to each of the plurality of thermal sensors 21.

The performance of each plasmonic element 30 is believed to depend on the thickness and material of the conducting layer 33 and the geometries of the plasmonic structures 32, which can be optimised in order to achieve improved transmission and narrower FWHM for better signal detection. It is believed that, while a thicker conducting layer 33 results in smaller transmission, reducing the conducting layer 33 thickness such that it is roughly as thin as its surface depth (close to or below 25 nm) results in a reduction in performance due to substantial coupling.

In an example, the conducting layer 33 thickness is chosen as 75 nm which is around three times its skin depth to ensure no or at worst minimal coupling exists between the top and bottom layers of the conducting layer 33 in order to preserve surface plasmon resonances at the metal-dielectric interfaces. The use of plasmonic structures 32 corresponding to hole arrays in the conducting layer 33 with an infrared transmissive dielectric medium 34 exhibit angle and polarisation-independent operation due to the circular geometry, which may advantageously enhance transmission.

Regarding the size of the plasmonic structures 32 (when realised as holes), generally it is found that smaller plasmonic structures 32 leads to weaker transmission whereas larger plasmonic structures 32 result in wider FWHM. In an example, plasmonic structures 32 with a diameter of approximately half the size of the period between adjacent structures 32 is utilised.

According to an embodiment, in use, each image sensor 20 captures an image (“component image”) of the imaging region 93 simultaneously (or at least, substantially simultaneously). For the purpose of this disclosure, reference may be made to a captured component image of the sample 90 although, generally, it is expected that the imaging region 93 has a larger extent than the sample (although, of course, the sample 90 may be sufficiently large to cover all, or most of, the imaging region 93).

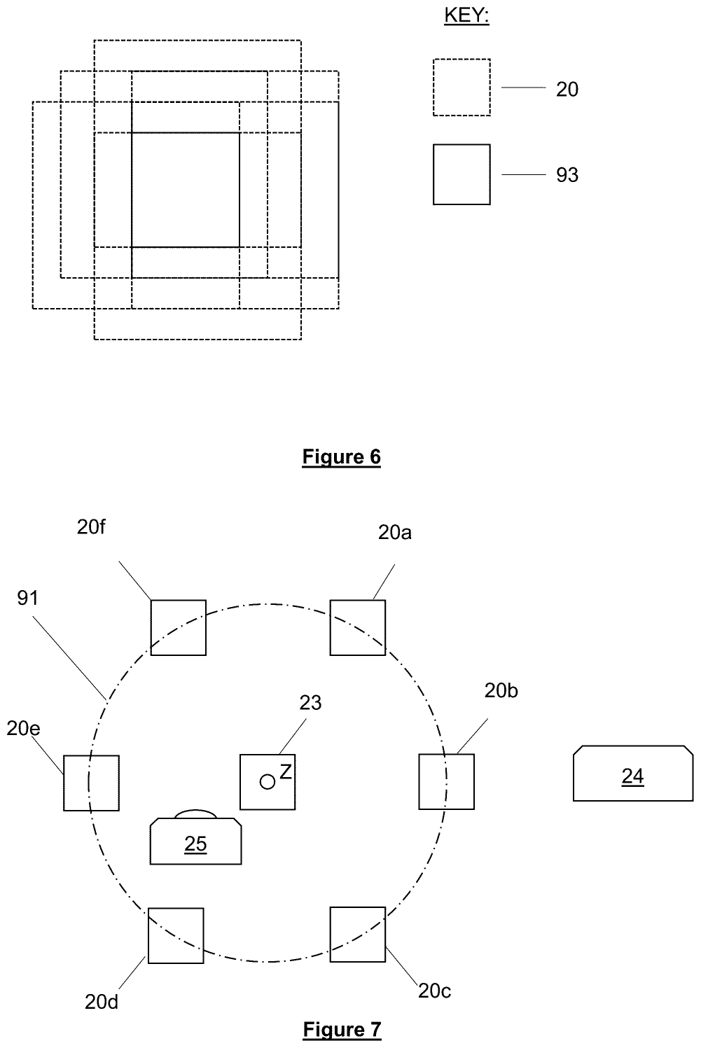

As should be understood, as illustrated in FIG. 6, each image sensor 20 captures a different view due to being offset with respect to one another. However, the resulting thermal multispectral image should be understood as an image of the common view for all image sensors 20 (i.e., a region in front of the image sensors 20 viewed by each image sensor 20). That is, the system 10 is arranged to treat the common viewed area as the imaging region 93, which may require a calibration to ensure correct mapping between pixels of each image sensor 20. An image co-registration algorithm can be used to determine the correct overlap of the images captured by the individual image sensors 20. For example, the separate images captured by each image sensor 20 are combined by the image processor 12 into a single image having multispectral pixels 90; that is, each pixel 90 is associated with a number of components equal to the number image sensors 20 such that each component is associated with a unique one of the image sensors 20. It should be understood that the concept of a “single image” is not intended to be limiting; instead, it should be understood that the imaging region 93 can be imaged via the plurality of image sensors 20 and, during processing, individual pixels representing said image can be identified having components derived from each image sensor 20.

In an alternative embodiment, the thermal imager 11 comprises an integrated image sensor (not shown) configured to capture multiple spectral bands. For example, Reference [2] (incorporated herein by reference) describes a multispectral filter array in thermal wavelengths which can be adapted for use as a component of the thermal imager 11. The integrated image sensor can replace several or all of the image sensors 20 described above. The thermal imager 11 can comprise multiple integrated image sensors. Typically, the integrated image sensor utilises, in effect, a mosaic of bandpass filters 22 such that the resulting images for the mosaicked bandpass filters 22 are substantially overlapping, advantageously thereby avoiding a need for image registration.

Referring to FIG. 7, in an embodiment, the thermal imager 11 further comprises a reference thermal sensor 23 configured to capture an image simultaneously, or at least in combination with, the images captured by image sensors 20. The reference thermal sensor 23 can comprise a same sensor type as the thermal sensor 21 of at least one of the thermal sensors 21. In a preferred implementation, all thermal sensors 21 and the reference thermal sensor 23 utilise an identical sensor such as the previously disclosed FLIR LeptonTM sensors. The reference thermal sensor 23 differs from the thermal sensors 21 in that it is not coupled to a bandpass filter 22 and therefore images the entire operating band 83 (see FIG. 2). The reference thermal sensor 23 can enable non-uniformity correction of the thermal spectral bands associated with the image sensors 20. In an implementation, as shown, the reference thermal sensor 23 is located at, or substantially at, the optical axis of the (Z) of the optical system 13. More generally, in an embodiment, the reference thermal sensor 23 is optically coupled to the same optical system 13 as the image sensors 20. The reference thermal sensor 23 can be arranged to generate a “control image”.

The thermal imager 11 of the embodiment of FIG. 7 also comprises a range sensor 24 configured to capture range information (“range image”) simultaneously, or at least in combination with, the images captured by image sensors 20. The range sensor 24 can comprise a time-of-flight sensor or other sensor suitable for obtaining distance information representing the distance between the sample 90 and the thermal imager 11. The range sensor 24 can be implemented as a point-cloud distance sensor (e.g., snapshot lidar), thereby enabling capture of a 3D point-cloud image, such that each multispectral pixel 94 is augmented with range information.

The thermal imager 11 of the embodiment of FIG. 7 also comprises a visible light sensor 25 configured to capture visible light (e.g., RGB) information (“visible image”) simultaneously, or at least in combination with, the images captured by image sensors 20. The visible light sensor 25 can comprise a standard RGB sensor. The visible light sensor 25 can, instead, either comprise a monochrome visible light sensor or a multispectral or hyperspectral visible light sensor. In an implementation, as shown, the visible light sensor 25 is located at, or substantially at, the optical axis of the (Z) of the optical system 13. More generally, in an embodiment, the visible light sensor 25 is optically coupled to the same optical system 13 as the image sensors 20. In another embodiment, the visible light sensor 25 is coupled to its own optical system (not shown) different to that of the image sensors 20.

In the case of an embodiment comprising one or more of: a reference thermal sensor 23; a range sensor 24; and a visible light sensor 25, (such an embodiment is referred to herein as “additional sensor embodiment”) each multispectral pixel 94 of the thermal multispectral image can be associated with control information derived from the control image, range information derived from the range image, and/or visible light information derived from the visible light image, as applicable (“per pixel information”). However, in an alternative, one or more of the control information, range information, and visible light information can be associated with the thermal multispectral image as a whole (e.g., representing global properties of the multispectral image rather than per pixel properties). It is expected, however, that at least the visible light information is implemented as per pixel information. An image co-registration algorithm, such as that already mentioned in respect of the captured by the individual image sensors 20, can be utilised to combine the control information, range information, and/or visible light information into the thermal multispectral image.

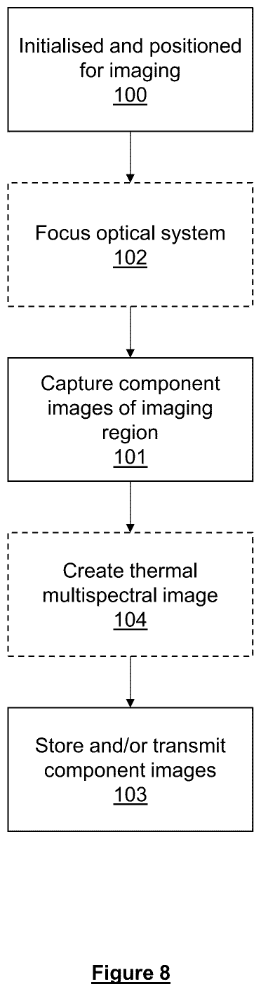

FIG. 8 shows a method for generating a thermal multispectral image according to an embodiment. The method is applicable to the thermal imager 11 herein described.

At step 100, the thermal imager 11 is initialised and arranged to image an imaging region 93 of interest. Typically, the imaging region 93 will comprise a sample 90 of interest, however, it is anticipated for certain calibration procedures, a sample 90 may be absent. However, for the purpose of elucidating the present method, it is assumed that a sample 90 is present and this term is used synonymously with imaging region 93.

At step 101, the thermal imager 11 is instructed to capture component images for each thermal band associated with the thermal imager 11 (e.g., six component images as per the embodiment shown in FIG. 4—each component image can therefore be understood as a monochrome image). Depending on the embodiment, the thermal imager 11 can receive said instruction via a human control interface of the thermal imager 11 itself or via a command communicated to the thermal imager 11, for example, from a control module implemented within the computer system of the image processor 12.

Optionally, at step 102, the thermal imager 11 is configured to operate the optical system 13 to ensure the sample 90 is in focus with respect to the image sensors 20 before image capture at step 101. In embodiments utilising a visible light sensor 25, the focusing may be achieved using known techniques and implemented using the visible light sensor 25; in this way, the visible light sensor 25 acts as a proxy for the image sensors 20 when focusing the optical system 13. Alternatively, the optical system 13 can have a set focus (e.g., where the distance to the sample 90 is consistent between uses) or is manually adjustable by a user.

In any event, the result of step 101 is a component image captured for each image sensor 20. These can, as discussed, be captured substantially simultaneously. However, assuming that the sample 90 is stationary with respect to the thermal imager 11, the component images can be captured in sequence. In the additional sensor embodiment, the reference thermal sensor 23; range sensor 24; and/or visible light sensor 25 can be operated at this stage to capture its associated control image, range image, and/or visible light image.

At step 103, all capture images are either or both of stored in a memory storage of the thermal imager 11 or communicated to the image processor 12.

In a variation, step 104 precedes step 103 and provides for the generation of a thermal multispectral image from at least the captured component images. The resulting thermal multispectral image is stored in the memory storage and/or communicated to the image processor 12, either in place of or in addition to at least the captured component images. The thermal multispectral image can also comprise information derived from the control image, range image, and/or visible light image if applicable. The thermal multispectral image therefore differs from the component images, which themselves are monochrome, as each multispectral pixel 94 of the thermal multispectral image comprises intensity information for each thermal band.

Step 104 can require a predetermined calibration between at least the plurality of image sensors 20 to enable mapping of the corresponding portions of the imaging region 93 images by each image sensor 20, due to each image sensor 20 having a different view of the imaging region 93.

Alternatively, the generation of the thermal multispectral image can be performed by the image processor 12 subsequently to being provided the component images. In this case, each component image should be labelled (e.g., with metadata or via file naming) to enable the image processor 12 to identify each related component images. It should be understood that a set of component images can be processed as a single thermal multispectral image, and vice versa. For the purposes of the remaining disclosure, the concept of a set of component images and a corresponding single thermal multispectral image are considered equivalent, unless otherwise stated.

The resulting thermal multispectral image comprises an operating band resolution equal to the number of image sensors 20. For example, the operating band resolution corresponds to the six thermal bands of the embodiments described herein. The term “band resolution” therefore refers to the number of distinct measurements available over the operating band for a single thermal multispectral image capture.

The inventors have found that the thermal multispectral images resulting from the use of the thermal imager 11 described herein can be improved using a suitably configured image processor 12.

### Spectral Filter

In an embodiment, a spectral reconstruction module 41 (“spectral filter”) is implemented by the image processor 12. In the present embodiment, a recent technique called “Algorithmic Spectrometry” is used to estimate the incident radiation at the specific wavelengths using a weighted combination of the spectral responses of the image sensors 20. The spectral filter utilises a set of filters to capture narrow-band spectral features as well as the broad envelope of radiation over the operating band 83.

The filters can take the form of Gaussian, rectangular, or triangular shapes, thereby allowing several potentially wide band intrinsic responses from the collection of image sensors 20 to form approximate narrow-band spectral responses at the peak wavelength of each thermal band. In an implementation, triangular bandpass filters are utilised as these are found to produce better fits to the weighted combination of spectral responses with the algorithmic spectrometry method. In this implementation, a desired spectral shape is approximated using an optimised least Mean Square Error (MSE) fit by calculating a set of weighting factors corresponding to the measured responses of the image sensors 20 at specific temperatures.

$$W = {( {A}^{T} A + ∅ )}^{- 1} {A}^{T} R \qquad [ Eq . 1 ]$$

$$A = [ \begin{matrix}{R}_{T 1} ( {λ}_{1} ) & {R}_{T 2} ( {λ}_{1} ) & ⋯ & {R}_{TM} ( {λ}_{1} ) \\ {R}_{T 1} ( {λ}_{2} ) & {R}_{T 2} ( {λ}_{2} ) & & {R}_{TM} ( {λ}_{2} ) \\ & ⋮ & ⋱ & ⋮ \\ {R}_{T 1} ( {λ}_{6} ) & {R}_{T 2} ( {λ}_{6} ) & ⋯ & {R}_{TM} ( {λ}_{6} )\end{matrix} ] \qquad [ Eq . 2 ]$$

Here W corresponds to the set of weighing factors for spectral radiance output, A is the matrix formed by the intrinsic spectral radiance as a function of wavelength λ and applied temperature T, R is the desired spectral shape of the triangular filters, and Ø is zero for ideal, noiseless measurements. A has a variable size depending on the use case; in terms of processing by the spectral filter on the component images of the image sensors 20 (e.g., on the six component images), the size is 40×6 (assuming that 40 different temperatures are utilised).

The spectral radiance matrix, A is reconstructed around imaging of a temperature controlled heatbed (serving as a blackbody) subjected to various temperatures between 40 and 160° C. The incident flux is approximated from the defined spectral radiance matrix by taking the predetermined weights for the filters.

$${S}_{Δ} = \sum {w}_{{T}_{i} {λ}_{j}} {S}_{P} \qquad [ Eq . 3 ]$$

### Spectral Reconstruction

In an embodiment, a spectral reconstruction module 41 is utilised by the image processor 12 for generating “reconstructed multispectral images” from thermal multispectral images. The reconstructed multispectral images have a band resolution greater than that of the thermal multispectral image. It is believed that, at least in the case of the thermal imager 11 described herein, this is beneficial, at least in part, due to the overlapping thermal bands 80, although the present disclosure is not intended to be limited to any particular theory. The inventors have found that the resulting reconstructed multispectral images can advantageously, at least in certain circumstance, show an improvement over the thermal multispectral image for use in sample identification and/or characterising purposes.

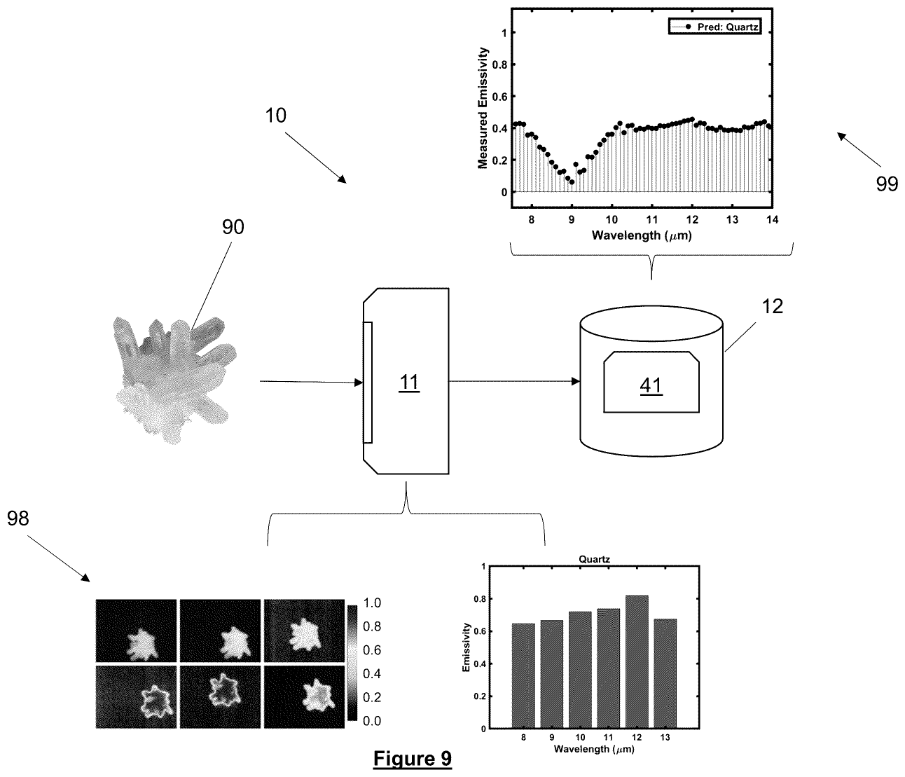

FIG. 9 shows a schematic representation of system 10 implementing image processor 12 according to an embodiment, in which a spectral reconstruction module 41 is shown implemented within the image processor 12. The spectral reconstruction module 41 is configured to process thermal multispectral images in order to generate resulting reconstructed multispectral images 99 which can be contrasted with the lower resolution thermal multispectral images 98 as captured. The spectral reconstruction module 41 implements a pretrained machine learning algorithm, typically having been trained to generate reconstructed multispectral images for a particular class of sample 90. For the present purposes, the sample class is “minerals” which can include various sample types, for example, amethyst, calcite, pyrite, and quartz.

In an embodiment, the spectral reconstruction module 41 is trained using known high-resolution thermal spectra (“known spectra”) for specific sample types of the sample class (that is, at least the thermal band resolution intended for the reconstructed multispectral image) and thermal multispectral images captured of samples 90 of the same sample type. That is, the known spectra correspond to the ground truth as used in machine learning training techniques. The known spectra can be synthesised to a thermal band resolution intended for the reconstructed multispectral image from higher thermal band resolutions. In the examples herein, the thermal band resolution intended for the reconstructed multispectral images is 64 spectral points.

Generally, the thermal multispectral images for training should be sourced from the same hardware as intended to be used in conjunction with the trained spectral reconstruction module 41. This can be a thermal imager 11 as per an embodiment herein described, although it may be that the present technique is suitable for use with other thermal multispectral imaging hardware such as those disclosed in the background.

For training, a set of training images is created by capturing thermal multispectral images of each training sample at a variety of temperatures (controlled, for example, by a heated sample holder). The thermal imager 11 is arranged for capturing thermal multispectral images of each training sample such that each thermal multispectral image is associated with a record (for example, as associated metadata) of the temperature and training sample type as captured. In an example, the temperature was raised at a substantially linear rate between a lower limit and an upper limit, for example, between 40 and 160° C.

The change in sample temperature is useful for geological samples in which little to no change in composition is expected over a reasonable temperature range. However, it is anticipated that certain sample classes are not amenable to changes in temperature in which case a number of thermal multispectral images are obtained at a relatively constant temperature. The thermal multispectral images can be associated with metadata identifying the sample temperature when captured. In variations, other factors in addition to, or alternatively to, temperature may be adjusted. For example, the “temperature” of illumination of the sample 90 may be changed where it is expected that the sample 90 will have characteristic reflectance spectra (as opposed to blackbody emission spectra).

The spectral reconstruction module 41 is trained on the captured thermal multispectral images making up the set of training images using the corresponding known spectra for the particular sample type associated with each thermal multispectral image. The output reconstruction layer of the machine learning algorithm comprises N nodes representing desired band resolution of the reconstructed multispectral images. In a particular implementation, the desired band resolution is 64 reconstructed thermal bands and, therefore, N=64. The reconstructed thermal bands span over the operating band 93 (e.g., 7-14 μm).

In a specific example, the spectral reconstruction module 41 implements an encoder-decoder architecture where a series of convolutional and pooling layers in the encoder path operate on the input thermal multispectral images in order to construct a high-level feature representation. Convolutional layers leverage sparse interactions (local connectivity), parameter sharing, and equivariant representations in the multispectral image. The convolutional layers are followed by the Leaky RELU activation function which introduces non-linearity into the network. The resulting high-level features due to the encoder are subsequently passed through a decoder path that consists of up-sampling and transposed deconvolutional layers. This encoder-decoder architecture is followed by a small “reconstruction head” to reconstruct the final spectral response. The network was trained to minimise Huber loss between the reconstructed (predicted) output spectra and theoretical emissivity spectra (ground truth) using Adam optimiser with a learning rate of 0.001. Huber loss was used due to its less sensitivity to outliers than mean squared error loss. Huber loss is a piecewise function highly tolerant to outliers for robust learning. The reconstruction network development and experimentation processes were implemented in Python using Keras and Tensor flow libraries on a computing machine equipped with an Nvidia Quadro6000 graphics processor. Other processor(s) and/or libraries can be utilised suitable for training of an appropriate neural network.

In an embodiment, the spectral reconstruction module 41 is trained on a training set comprising both captured thermal multispectral images and simulated thermal multispectral images. The simulated thermal multispectral images reflect the important spectral characteristics of the thermal multispectral data. The output reconstruction layer of the machine learning algorithm comprises N nodes representing the desired band resolution of the recovered spectra of known and unknown samples. In a particular implementation, the desired band resolution is 64 reconstructed thermal spectral points and, therefore, N=64. The reconstructed thermal bands span over the operating band 83 (e.g., 8-14 μm).

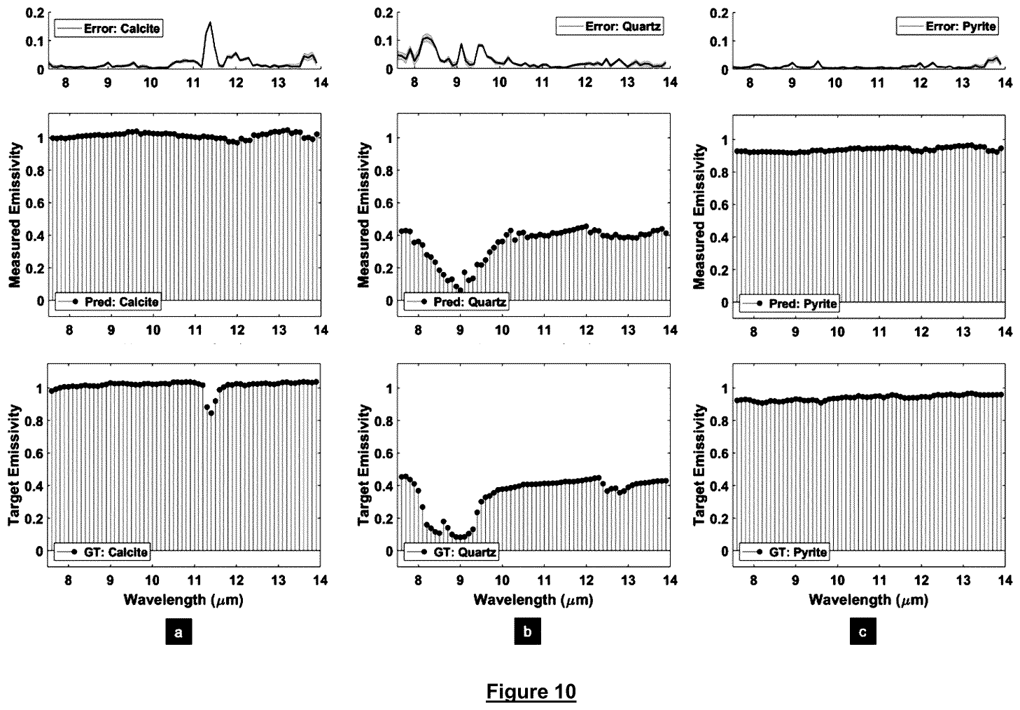

In an example, after training, the reconstruction module 42 was used to blindly test the measurement made by the thermal imager 11 of a calcite mineral, where the calcite mineral's spectra were not utilised in training. A dataset is made of 400 samples (80×60×6×400) and labeled with four classes: graybody, pyrite, quartz, and calcite were used to test the model performance (the image analyser 12). While the model had “seen” the mineral samples pyrite and quartz during training, the emissivity spectra of calcite is blindly reconstructed. FIG. 10 illustrates the results of the spectral reconstruction algorithm implemented by the trained image analyser 12 to accurately recover the unknown spectra. In FIG. 10 shows the ground truth vs predicted thermal signatures for a. Calcite, b. Quartz and c. Pyrite at 100° C. in the thermal range, 8-14 μm. Calcite and quartz used in this experiment are optically transparent, whereas pyrite resembles gold. Quartz has low thermal emissivity with absorption peak at 8-9 μm range, but calcite and pyrite have high emissivity. The maximum error in peak localization while reconstruction is less than 0.2. While the optically transparent varieties of quartz and calcite look similar to human eye, the deep learning-based image analyser 12 was shown to potentially assist in identifying the minerals.

For example, the performance of the proposed algorithm for the image analyser 12 is measured using maximum peak localization error and prediction error on the tested spectra which were 0.021 and 0.0003 respectively. A peak was defined to be correctly reconstructed if the difference between predicted and ground truth values is less than 5%. Overall, ground truth spectra were correctly reconstructed for the minerals.

The thermal imager 11 according to embodiments herein described is expected to be useful in applications in which thermal multispectral imaging is expected to provide markedly improved information of an imaged sample 90 in relation to its emission, either blackbody or under artificial illumination, in the long-infrared. The thermal imager 11 is expected to be relatively lightweight and capable of obtaining thermal multispectral images relatively instantaneously; that is, it may advantageously not be required to be held “steady” for as long as other techniques such as those in which sequential images are taken of a target using different bandpass filters. This may provide an advantage in particular in situations where the sample 90 is liable to change (e.g., deteriorate or move out of view) during imaging.

Another advantage may be in the spatial resolution of the captured thermal multispectral image, which may enable multiple different samples 90 to be images simultaneously within the same imaging region 93.

The image processor 12 according to embodiments herein described may advantageously improve the capacity to utilise the output of the described thermal imager 11 (or, possibly, other thermal multispectral imaging hardware) for reproduction of sample spectra. For example, the image processor 12 may improve of the capacity of the imaging system 10 (or another system using the reconstructed multispectral images output by the image processor 12) to distinguish between similar spectra in comparison to the thermal multispectral images.

Another advantage may be in the spectral resolution of the captured thermal multispectral image, which may enable identifying different samples 90 from their spectral fingerprints in the recovered spectra.

The spectral reconstruction module 41 according to embodiments herein described herein may advantageously recover the thermal emissivity of the material passively in a non-destructive fashion using the proposed multispectral system but is equally applicable to active thermal imaging.

Although embodiments are described in relation to mineral sample identification, it is anticipated that embodiments of the system 10 herein described may be useful for other purposes. For example, thermal multispectral imaging is known to be useful for non-destructive material study, optical gas imaging (e.g. for identifying minute fugitive emission of gases and for the safe detection and study of plumes and gas leaks), for inspection of hot and cold objects during combustion or to understand explosion dynamics in detail, for “seeing through walls” such as for improved surveying of house and other industrial leaks and for characterising the buried objects. Also, it is expected that embodiments of the system 10 may be useful for medical applications such as thermal detection of embedded tumours, to detect the change in palm and finger temperatures, to study magnitude and pattern of the emitted heat in relation to Rheumatoid arthritis and osteoarthritis, cerebral study and thermal marker detection, for example identify abnormal markers in head, torso, arms, hands and legs and associate it with disease, and thermal physiological monitoring, for example to study thermogenesis and peripheral blood flow and for respiratory physiology and quantitative assessment.

The thermal imager 11 can be, in an embodiment, provided with an active cooling module (not shown) configured to lower the thermal temperature of the thermal sensors 21 (and, generally, the optical environment thereof) to enable thermal multispectral imaging of room temperature or below samples 90. For example, when cooled, the thermal imager 11 can be suitable for imaging non-heated (e.g., room temperature) samples.

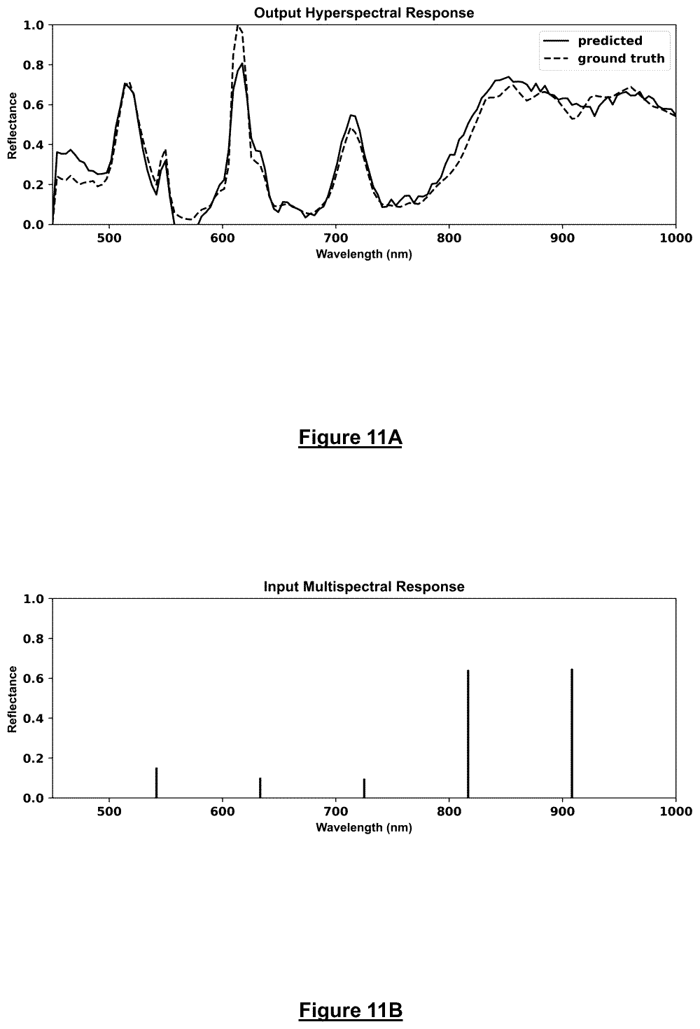

FIGS. 11A and 11B show experimental results based on reconstruction using an image processor 12 trained based on multispectral images set in the near-infrared and visible spectra, rather than the thermal spectrum. In this case, in order to produce the multispectral images, a hyperspectral camera (in the present case, a commercially available Cubert Firefly hyperspectral camera (herein “CF camera”)) was utilised to capture hyperspectral images of various man-made objects and natural scenes. The CF camera has 138 spectral bands ranging from 450-1000 nm providing a spectral resolution of approximately 4 nm. The CF camera has a spatial resolution of 50×50 pixels. The dataset includes images of both outdoor and indoor natural scenes with varying illumination conditions, and objects made of different materials such as leaves, flowers, fruit, wood, and metal. Images for the dataset were captured at different times of the day and under different weather conditions to ensure its diversity and representativeness of real-world scenarios.

For training and testing, the resulting hyperspectral images were down-sampled to create a dataset of multispectral images each with 6 spectral bands, providing a spectral resolution of approximately 90 nm. This was achieved by sampling the hyperspectral cube at a 26-band sampling interval. The resulting multispectral dataset is organized into train, validation, and test sets, containing 300, 100, and 100 pairs of multi-and hyperspectral images, respectively.

The experimental setup differs from the embodiments described with respect to the thermal imager 11 in that there is no effective overlap between the adjacent multispectral bands, as each multispectral band is generated from a unique contiguous range of hyperspectral bands.

FIG. 11A shows an example of a groundtruth 70 (i.e., the hyperspectral response measured by the hyperspectral camera, before down-sampling to a multispectral response) and a prediction output 71 by the image processor 12 for a particular pixel of the hyperspectral camera. FIG. 11B shows the down-sampled multispectral response 72 for that same pixel. In practice, the groundtruth 70 response of FIG. 11A was first down-sampled to the multispectral response 72 of FIG. 11B before the image processor 12 generated the prediction output 71 response shown in FIG. 11A from the multispectral response 72.

FIGS. 11A and 11B are therefore indicative of an effective per pixel reconstruction of the hyperspectral response. The image processor 12 advantageously may therefore be able to retrieve spectral reflectance across different pixel locations, where each location represents a unique combination of surface materials and illumination conditions.

It is also expected, based on the results shown in FIGS. 11A and 11B, that the image processor 12 can be modified to operate over other bands within the infrared spectrum. For example, an image processor 12 trained and configured to operate within the “infrared window” (e.g., approximately 0.78 to 1 microns) may be of particular utility.

Further modifications can be made without departing from the spirit and scope of the specification. For example, the thermal imager 11 can be calibrated by, for example, performing flatfield correction for removing specular noise.

### References

[1] Shaik, Noore Karishma, et al. “Multispectral thermal camera using copper plasmonics.” Emerging Imaging and Sensing Technologies for Security and Defence VI. Vol. 11868. SPIE, 2021.
[2] Noor-E-Karishma Shaik, Luke Weston, A. Nirmalathas, and Ranjith R. Unnithan. “Aluminum Plasmonics in Thermal Wavelengths for Multispectral Imaging.” 2020 Conference on Lasers and Electro-Optics (CLEO). IEEE, 2020.

1. A sample analysis method, comprising:
obtaining a multispectral image of a first sample of a sample class, said multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and
applying a sample image analyser to said multispectral image, wherein the sample image analyser implements a pretrained machine learning algorithm configured to generate a reconstructed spectrum comprising a second number (m) of spectral points, wherein the second number is larger than the first number (m>n),
wherein the first number is two or greater (n≥2), and wherein the unique spectral bands are arranged to cover an operating band.

2. The method of claim 1, wherein either or both:
the multispectral image is a thermal multispectral image; and
the operating band corresponds to, or substantially to, the range of wavelengths 7-14 μm or 2-5.5 μm.

3. The method of claim 1, wherein the operating band corresponds to, or substantially to, an infrared band such as the range of wavelengths 0.78-1 μm (e.g., near infrared) and/or to the visible band such as the range of wavelengths 0.4-0.78 μm.

4. The method of claim 1, wherein each spectral band is characterized by a unique peak transmission wavelength.

5. The method of claim 1, wherein the first number is six (n=6) and the second number is 64 (m=64).

6. The method of claim 1, wherein the multispectral image comprises an array of multispectral pixels, each having a number of components equal to the first number (n) derived from the component images.

7. The method of claim 6, wherein a reconstructed spectrum is generated for two or more, or all, multispectral pixels of the multispectral image.

8. The method of claim 6, wherein a spectral filter is applied to each multispectral pixel of the multispectral image preconfigured to estimate the actual intensity for each spectral band based on predetermined weighted combinations of a plurality of the spectral bands.

9. The method of claim 8, wherein the predetermined weightings are determined by reference to multispectral images obtained of a heatbed having a controllable blackbody radiation profile.

10. The method of claim 1, wherein the pretrained machine learning algorithm is trained according to the steps of:
generating a training set comprising a plurality of training images, each training image being a multispectral image captured of a particular known sample type of the sample class;
obtaining at least one known spectrum for the sample type, said known spectra having at least a resolution equal to the second number (m); and
training a preselected machine learning algorithm using the training set and using the at least one known spectrum as a ground truth to produce the pretrained machine learning algorithm.

11. The method of claim 10, wherein the machine learning algorithm implements an encoder-decoder architecture, optionally comprising one or more of:
an encoder-decoder architecture where a series of convolutional and pooling layers are in the encoder path and/or up-sampling and transposed deconvolutional layers are implemented in the decoder path; and
a Leaky RELU activation function for introducing non-linearity.

12. The method of claim 10, wherein the training set includes training images of a same sample type obtained at different temperatures of the sample type.

13. The method of claim 1, wherein the multispectral image is obtained from an imager comprising:
a plurality of image sensors, each associated with a unique one of the spectral bands and configured to generate the component image corresponding to its spectral band, arranged such that each image sensor is enabled to simultaneously capture an image of an imaging region, or
at least one integrated image sensor associated with a unique two or more of the spectral bands and configured to generate the component images corresponding to each of its spectral bands.

14. (canceled)

15. The method of claim 13, wherein each image sensor comprises:
a sensor configured for capturing a two-dimensional image, and
a bandpass filter configured to limit the sensitivity of the sensor to the corresponding spectral band of the particular image sensor.

16. The method of claim 15, wherein at least one bandpass filter comprises a plasmonic element for bandpass filtering.

17. The method of any one of claim 13, wherein the image sensors are optically coupled to an optical system, wherein the optical system is configured for enabling simultaneous imaging of the imaging region by the imager sensors or wherein the, or each, image sensor is actively cooled.

18. The method of claim 13, wherein the imager further comprises one or more of:
a reference thermal sensor;
a range sensor; and
a visible light sensor
or wherein the sample class is minerals and the sample being analyzed is known to be of said sample class.

19. (canceled)

20. (canceled)

21. (canceled)

22. A sample analysis system comprising:
an imager configured to capture multispectral images of a first sample of a sample class, each multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and
an image processor configured to apply a sample image analyser to said multispectral image, wherein the sample image analyser implements a pretrained machine learning algorithm configured to generate a reconstructed spectrum comprising a second number (m) of spectral points, wherein the second number is larger than the first number (m>n),
wherein the first number is two or greater (n≥2), and wherein the unique spectral bands are arranged to cover an operating band.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (cancelled)

40. (canceled)

41. (canceled)

42. A camera device comprising:
an imager configured to capture multispectral images of a first sample of a sample class, each multispectral image corresponding to a first number (n) of component images, each component image associated with a unique spectral band and representing, at each pixel of the particular component image, an intensity of incident radiation, wherein the spectral band of each component image overlaps in part with at least one spectral band of another component image; and
an image processor configured to apply a sample image analyser to said multispectral image, wherein the sample image analyser implements a pretrained machine learning algorithm configured to generate a reconstructed spectrum comprising a second number (m) of spectral points, wherein the second number is larger than the first number (m>n),
wherein the first number is two or greater (n≥2), and wherein the unique spectral bands are arranged to cover an operating band of the long infrared spectrum,
wherein the imager comprises either or both of:
a plurality of image sensors, each associated with a unique one of the spectral bands and configured to generate the component image corresponding to its spectral band, arranged such that each image sensor is enabled to simultaneously capture an image of an imaging region; and
at least one integrated image sensor associated with a unique two or more of the spectral bands and configured to generate the component images corresponding to each of its spectral bands.

43. A computer program comprising code configured to cause a computer to implement the method of claim 1 when said code is executed by the computer.

44. (canceled)
